(19) United States
(12) Patent Application Publication
(10) Pub. No.: US 2026/0121425 A1
(43) Pub. Date: Apr. 30, 2026

(54) CHARGING-DISCHARGING SYSTEM

(71) Applicant: SK On Co., Ltd., Seoul (KR)

(72) Inventor: Yun Jo JUNG, Daejeon (KR)

(21) Appl. No.: 19/367,770

(22) Filed: Oct. 23, 2025

(30) Foreign Application Priority Data
Oct. 24, 2024 (KR) 10-2024-0146788

(51) Int. Cl. H02J 7/00; G01K 15/00; H01M 10/42; H01M 10/48

(52) U.S. Cl. CPC H02J 7/50; G01K 15/005; H01M 10/4285; H01M 10/482; H01M 10/486; H02J 7/80; H02J 7/975

(57) ABSTRACT

The present disclosure relates to a charging-discharging system comprising: a charging-discharging device defining a detachable space in which one or more battery cells are detachably disposed and charging and discharging the battery cells; and a calibration device detachably disposed in the detachable space. The charging-discharging device and the calibration device are referred to with reference to the contents described in the present specification.

### CROSS-REFERENCE TO RELATED PATENT APPLICATION

The present application claims priority under 35 U.S.C. § 119(a) to Korean patent application number 10-2024-0146788 filed on October 24, 2024, in the Korean Intellectual Property Office, the entire disclosure of which is incorporated by reference herein.

### BACKGROUND OF THE INVENTION

### 1. Field

The present disclosure relates to a charging-discharging system. More specifically, the present disclosure relates to a charging-discharging system for improving a manufacturing process of a battery cell.

### 2. Description of the Related Art

A typical manufacturing process of a battery cell (or a secondary battery) may include a charging-discharging process of charging and discharging an assembled battery cell by using a charging-discharging device. Such a charging-discharging device may further include various components for measuring a temperature of the battery cell during charging and discharging in order to improve stability during performing the above-described charging-discharging process.

Meanwhile, due to repeated use of the charging-discharging device, precision of the charging-discharging device (for example, precision of a charging voltage and/or precision of a measured temperature) may deteriorate. Therefore, it is necessary to periodically calibrate the precision of the charging-discharging device. At least a part of such a periodic calibration process is performed manually by manpower, which not only includes a possibility of occurrence of human error but also entails disadvantages of having to bear cost and time required for securing manpower.

### SUMMARY OF THE INVENTION

The present disclosure has a problem to be solved of improving efficiency and stability of a manufacturing process of a battery cell.

The present disclosure has a problem to be solved of improving reliability of a charging-discharging device used in a manufacturing process of a battery cell.

The present disclosure has a problem to be solved of improving efficiency of a calibration process for improving reliability of a charging-discharging device.

Meanwhile, the present disclosure can be widely applied to fields of green technology such as an electric vehicle (EV), a battery charging station, an energy storage system (ESS), photovoltaics using a battery, and wind power using a battery. In addition, the present disclosure can be used for eco-friendly mobility including an electric vehicle and a hybrid vehicle in order to prevent climate change by suppressing air pollution and emission of greenhouse gases.

As a technical means to achieve the technical objects, a charging-discharging system according to the present disclosure may comprise: a charging-discharging device defining a detachable space in which one or more battery cells are detachably disposed and charging and discharging the battery cells; and a calibration device detachably disposed in the detachable space. The charging-discharging device may comprise: a charging-discharging portion including a charging-discharging terminal portion for charging and discharging the battery cells, and outputting current and voltage to the charging-discharging terminal portion at a preset set intensity value; a temperature measurement portion including a temperature measurement terminal portion for sensing a temperature of the detachable space, and measuring a temperature of the temperature measurement terminal portion to obtain a measured temperature value; and a charging-discharging control portion for controlling the charging-discharging portion and the temperature measurement portion. The calibration device may comprise: a first calibration portion including a first calibration terminal portion connectable to the charging-discharging terminal portion, and measuring current and voltage applied to the first calibration terminal portion to obtain a measured intensity value; and a second calibration portion including a second calibration terminal portion connectable to the temperature measurement terminal portion, and setting a temperature of the second calibration terminal portion to a preset set temperature value.

In one embodiment, the charging-discharging terminal portions and the first calibration terminal portions may be respectively provided in plurality, and the plurality of charging-discharging terminal portions and the plurality of first calibration terminal portions may correspond to each other in a one-to-one manner.

In one embodiment, the temperature measurement terminal portions and the second calibration terminal portions may be respectively provided in plurality, and the plurality of temperature measurement terminal portions and the plurality of second calibration terminal portions may correspond to each other in a one-to-one manner.

In one embodiment, the number of the plurality of temperature measurement terminal portions may be less than or equal to the number of the plurality of charging-discharging terminal portions.

In one embodiment, the temperature measurement terminal portion may extend in a preset direction, and the second calibration terminal portion may define an insertion space into which an extension end of the temperature measurement terminal portion is inserted.

In one embodiment, the temperature measurement terminal portion may further comprise a temperature sensor disposed at the extension end.

In one embodiment, the charging-discharging device may further comprise a charging-discharging frame in which the charging-discharging portion and the temperature measurement portion are disposed.

In one embodiment, the charging-discharging frame may be movable toward the calibration device disposed in the detachable space such that the charging-discharging terminal portion and the temperature measurement terminal portion are respectively connected to the first calibration terminal portion and the second calibration terminal portion.

In one embodiment, the charging-discharging control portion may calibrate the measured temperature value based on the set temperature value and the measured temperature value.

In one embodiment, when an absolute value of a difference between the measured temperature value and the set temperature value is greater than or equal to a reference temperature value, the charging-discharging control portion may calibrate the measured temperature value based on a temperature compensation value obtained by subtracting the measured temperature value from the set temperature value.

In one embodiment, the charging-discharging control portion may calibrate the set intensity value based on the set intensity value and the measured intensity value.

In one embodiment, when an absolute value of a difference between the measured intensity value and the set intensity value is greater than or equal to a reference intensity value, the charging-discharging control portion may calibrate the set intensity value based on an intensity compensation value obtained by subtracting the set intensity value from the measured intensity value.

In one embodiment, the charging-discharging control portion may simultaneously perform calibration of the measured temperature value and calibration of the set intensity value.

In one embodiment, the calibration device may further comprise a calibration control portion for controlling the first calibration portion and the second calibration portion.

In one embodiment, the calibration control portion may be capable of measuring whether a temperature of the second calibration terminal portion set by the second calibration portion matches the set temperature value.

In one embodiment, the calibration control portion may transmit and receive a control signal to and from the charging-discharging control portion.

In one embodiment, the calibration control portion may provide the measured intensity value and the set temperature value to the charging-discharging control portion.

In one embodiment, calibration through the first calibration portion and calibration through the second calibration portion may be performed simultaneously.

According to one aspect of the present disclosure, efficiency and stability of a manufacturing process of a battery cell may be improved.

According to another aspect of the present disclosure, reliability of a charging-discharging device used in a manufacturing process of a battery cell may be improved.

According to still another aspect of the present disclosure, efficiency of a calibration process for improving reliability of a charging-discharging device may be improved.

### BRIEF DESCRIPTION OF THE DRAWINGS

FIG. 1 is a diagram showing a control block diagram of a calibration device according to the present disclosure.

FIG. 2 is a diagram schematically showing an example of the calibration device viewed from the front according to the present disclosure.

FIG. 3 is a diagram schematically showing an example of the calibration device viewed from the side according to the present disclosure.

FIG. 4 is a diagram showing a control block diagram of a charging-discharging device according to the present disclosure.

FIG. 5 is a diagram schematically showing an example of the charging-discharging device viewed from the front according to the present disclosure.

FIG. 6 is a diagram showing a control block diagram of a charging-discharging system according to the present disclosure.

FIG. 7 is a diagram schematically showing an example in which a second calibration terminal portion included in the calibration device according to the present disclosure is connected to a temperature measurement terminal portion included in the charging-discharging device according to the present disclosure.

FIG. 8 is a flowchart for explaining an example of a calibration method of the charging-discharging device using the charging-discharging system of FIG. 6.

FIG. 9 is a flowchart for explaining a step of calibrating a measured temperature value of FIG. 8.

FIG. 10 is a flowchart for explaining a step of calibrating a set intensity value of FIG. 8.

### DETAILED DESCRIPTION

Hereinafter, the present disclosure will be described in detail with reference to the accompanying drawings. However, this is merely exemplary, and the present disclosure is not limited to the specific embodiments described as examples.

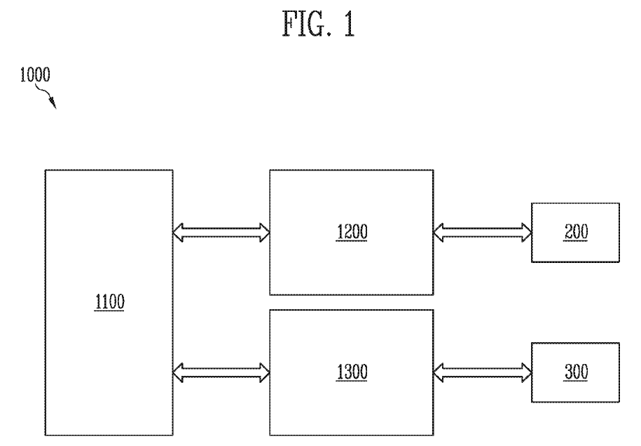

FIG. 1 is a diagram showing a control block diagram of a calibration device according to the present disclosure.

Referring to FIG. 1, the calibration device 1000 may comprise a first calibration portion 1200 and a second calibration portion 1300.

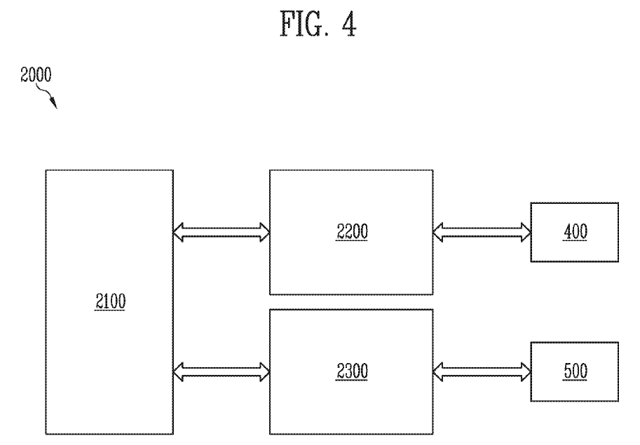

The first calibration portion 1200 may comprise a first calibration terminal portion 200. The first calibration terminal portion 200 may be connected to a charging-discharging terminal portion 400 (see FIG. 4) described below and may receive current and voltage from the charging-discharging terminal portion 400. The first calibration portion 1200 may measure the current and voltage applied to the first calibration terminal portion 200 to obtain a measured intensity value.

The second calibration portion 1300 may comprise a second calibration terminal portion 300. The second calibration terminal portion 300 may be connected to a temperature measurement terminal portion 500 (see FIG. 4) described below. The second calibration portion 1300 may set a temperature of the second calibration terminal portion 300 to a preset set temperature value.

In one embodiment, the calibration device 1000 may further comprise a calibration control portion 1100 for controlling the first calibration portion 1200 and the second calibration portion 1300.

For example, the calibration control portion 1100 may receive the measured intensity value from the first calibration portion 1200 and store the same. For example, the calibration control portion 1100 may store the set temperature value and may provide the stored set temperature value to the second calibration portion 1300. In addition, the calibration control portion 1100 may transmit and receive various control signals for performing preset various operations of the calibration device 1000 with various components constituting the calibration device 1000.

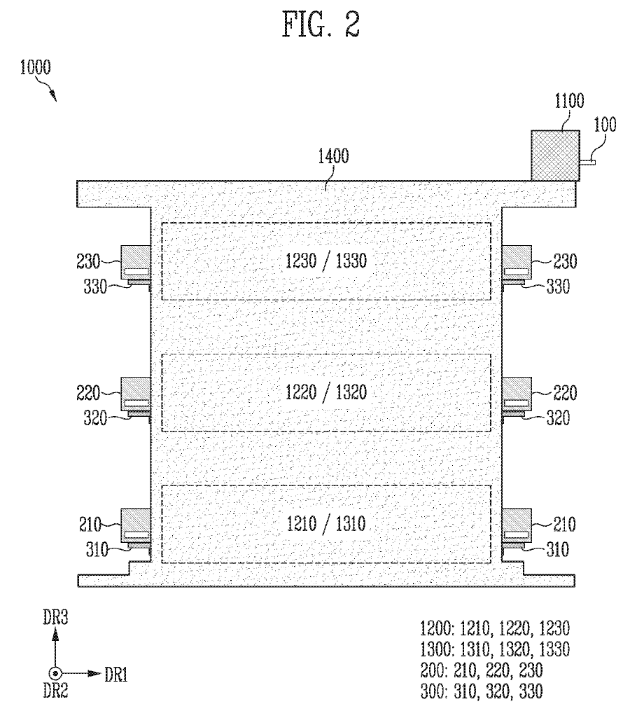

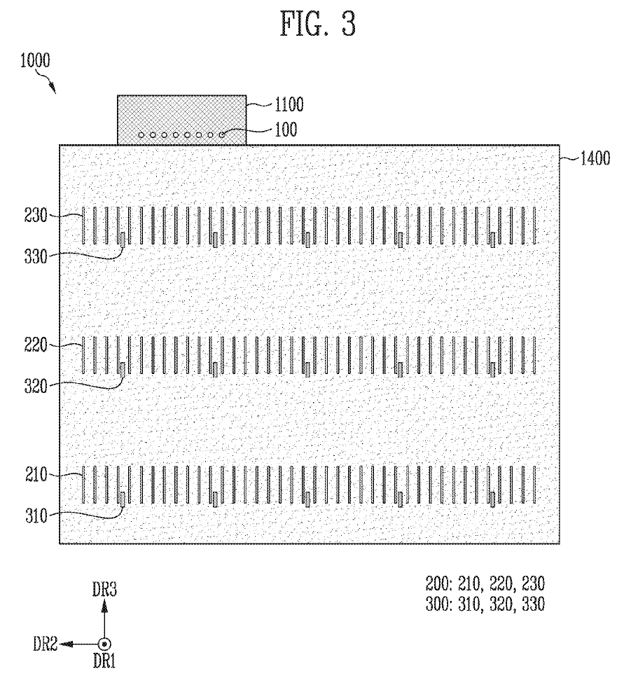

FIG. 2 is a diagram schematically showing an example of the calibration device viewed from the front according to the present disclosure. FIG. 3 is a diagram schematically showing an example of the calibration device viewed from the side according to the present disclosure.

In the present disclosure, first to third directions DR1, DR2, DR3 are defined. A first direction DR1 and a second direction DR2 may be perpendicular to each other. A third direction DR3 may be perpendicular to the first and second directions DR1 and DR2. For example, the third direction DR3 corresponds to a direction in which gravity acts, and may be referred to as a height direction or a thickness direction.

In the present disclosure, the term “front” may be understood as a surface viewed in the second direction DR2 of a plane defined by the first and third directions DR1 and DR3, and the term “side” may be understood as a surface viewed in the first direction DR1 of a plane defined by the second and third directions DR2 and DR3.

Hereinafter, descriptions of contents overlapping with those described with reference to FIG. 1 may be omitted.

Referring to FIGS. 2 and 3, in one embodiment, the calibration device 1000 may comprise an outer frame 1400. The outer frame 1400 may define a receiving space for accommodating at least one of the calibration control portion 1100, the first calibration portion 1200, and the second calibration portion 1300. For example, as shown in FIG. 2, the first calibration portion 1200 and the second calibration portion 1300 may be disposed in the receiving space of the outer frame 1400, and at least a part of the calibration control portion 1100 may be exposed to the outside of the outer frame 1400. However, the present disclosure is not limited thereto. For example, the calibration control portion 1100 may also be disposed in the receiving space of the outer frame 1400.

In one embodiment, the calibration control portion 1100 may comprise one or more calibration control terminal portions 100. The calibration control terminal portions 100 may protrude outward from the calibration control portion 1100 along a preset direction. The calibration control terminal portions 100 may be connected to a charging-discharging control portion 2100 (see FIG. 4) described below, and accordingly, the calibration control portion 1100 may transmit and receive control signals with the charging-discharging control portion 2100.

In one embodiment, the first calibration portion 1200 may comprise a plurality of first calibration portions stacked in two or more stages. For example, the first calibration portion 1200 may comprise a first-first calibration portion 1210, a first-second calibration portion 1220, and a first-third calibration portion 1230 stacked along the third direction DR3. The first-first calibration portion 1210, the first-second calibration portion 1220, and the first-third calibration portion 1230 may be disposed in the receiving space of the outer frame 1400, and in FIG. 2, schematic positions of the first-first calibration portion 1210, the first-second calibration portion 1220, and the first-third calibration portion 1230 in the receiving space are illustrated in dotted lines.

In the above-described embodiment, the first calibration terminal portion 200 may be composed of a plurality of first calibration terminal portions corresponding to the plurality of first calibration portions. For example, the first-first calibration portion 1210 may comprise a first-first calibration terminal portion 210, the first-second calibration portion 1220 may comprise a first-second calibration terminal portion 220, and the first-third calibration portion 1230 may comprise a first-third calibration terminal portion 230.

In this case, at least a part of the first calibration terminal portion 200 may be exposed to the outside of the outer frame 1400. For example, at least a part of the first-first calibration terminal portion 210, at least a part of the first-second calibration terminal portion 220, and at least a part of the first-third calibration terminal portion 230 may be respectively exposed to the outside of the outer frame 1400. Meanwhile, as shown in FIG. 3, each of the first-first calibration terminal portion 210, the first-second calibration terminal portion 220, and the first-third calibration terminal portion 230 may be provided in plurality.

In one embodiment, the second calibration portion 1300 may comprise a plurality of second calibration portions stacked in two or more stages. For example, the second calibration portion 1300 may comprise a second-first calibration portion 1310, a second-second calibration portion 1320, and a second-third calibration portion 1330 stacked along the third direction DR3. The second-first calibration portion 1310, the second-second calibration portion 1320, and the second-third calibration portion 1330 may be disposed in the receiving space of the outer frame 1400, and in FIG. 2, schematic positions of the second-first calibration portion 1310, the second-second calibration portion 1320, and the second-third calibration portion 1330 in the receiving space are illustrated in dotted lines.

In the above-described embodiment, the second calibration terminal portion 300 may be composed of a plurality of second calibration terminal portions corresponding to the plurality of second calibration portions. For example, the second-first calibration portion 1310 may comprise a second-first calibration terminal portion 310, the second-second calibration portion 1320 may comprise a second-second calibration terminal portion 320, and the second-third calibration portion 1330 may comprise a second-third calibration terminal portion 330.

In this case, at least a part of the second calibration terminal portion 300 may be exposed to the outside of the outer frame 1400. For example, at least a part of the second-first calibration terminal portion 310, at least a part of the second-second calibration terminal portion 320, and at least a part of the second-third calibration terminal portion 330 may be respectively exposed to the outside of the outer frame 1400. Meanwhile, as shown in FIG. 3, each of the second-first calibration terminal portion 310, the second-second calibration terminal portion 320, and the second-third calibration terminal portion 330 may be provided in plurality.

In one embodiment, the second-first calibration portion 1310, the second-second calibration portion 1320, and the second-third calibration portion 1330 may be disposed at substantially the same positions as the first-first calibration portion 1210, the first-second calibration portion 1220, and the first-third calibration portion 1230, respectively. In this case, the second-first calibration portion 1310, the second-second calibration portion 1320, and the second-third calibration portion 1330 may be provided as components physically and/or logically separated from the first-first calibration portion 1210, the first-second calibration portion 1220, and the first-third calibration portion 1230, respectively.

Meanwhile, in FIGS. 2 and 3, for clear and concise description, embodiments in which the first calibration portion 1200 and the second calibration portion 1300 are each configured in three stages are illustrated, but the present disclosure is not limited thereto. The first calibration portion 1200 and the second calibration portion 1300 may each independently be configured in one stage, two stages, or four or more stages.

FIG. 4 is a diagram showing a control block diagram of a charging-discharging device according to the present disclosure.

Referring to FIG. 4, the charging-discharging device 2000 may comprise a charging-discharging control portion 2100, a charging-discharging portion 2200, and a temperature measurement portion 2300.

The charging-discharging portion 2200 may comprise a charging-discharging terminal portion 400. The charging-discharging terminal portion 400 may be a terminal portion for charging and discharging a battery cell. Here, the term “battery cell” may mean various known structures including a positive electrode and a negative electrode, which can convert chemical energy into electrical energy through electrochemical reactions at the positive electrode and the negative electrode. The charging-discharging terminal portion 400 may be understood as a component electrically connected to the positive electrode and the negative electrode of the battery cell for charging and discharging the battery cell. The charging-discharging portion 2200 may output current and voltage to the charging-discharging terminal portion 400 at a preset set intensity value.

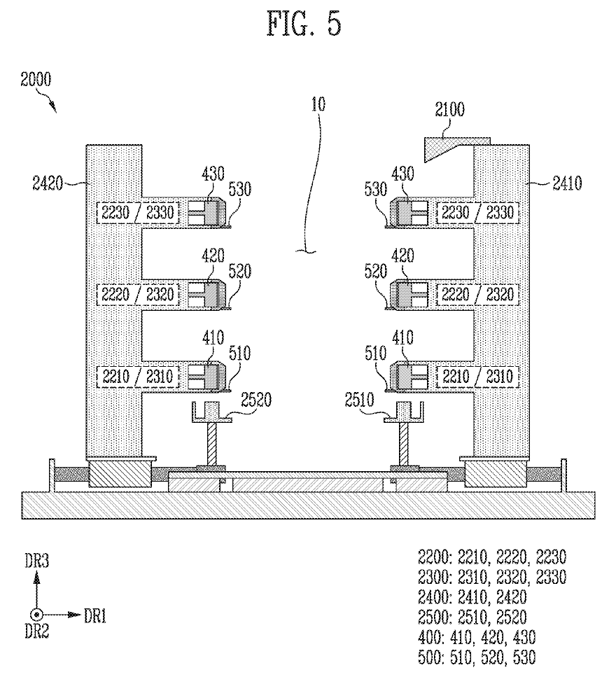

The temperature measurement portion 2300 may comprise a temperature measurement terminal portion 500. The temperature measurement terminal portion 500 may be a terminal portion for sensing a temperature of a detachable space 10 (see FIG. 5) in which charging and discharging of the battery cell is performed. The temperature measurement portion 2300 may measure a temperature of the temperature measurement terminal portion 500 to obtain a measured temperature value.

The charging-discharging control portion 2100 may control the charging-discharging portion 2200 and the temperature measurement portion 2300. For example, the charging-discharging control portion 2100 may store the set intensity value and may provide the stored set intensity value to the charging-discharging portion 2200. For example, the charging-discharging control portion 2100 may receive the measured temperature value from the temperature measurement portion 2300 and may store the same. In addition, the charging-discharging control portion 2100 may transmit and receive various control signals for performing preset various operations of the charging-discharging device 2000 with various components constituting the charging-discharging device 2000.

FIG. 5 is a diagram schematically showing an example of the charging-discharging device viewed from the front according to the present disclosure.

Hereinafter, descriptions of contents overlapping with those described with reference to FIG. 4 may be omitted.

Referring to FIG. 5, the charging-discharging device 2000 may define a detachable space 10 in which one or more battery cells are detachably disposed, and may charge and discharge the battery cells. For example, the charging-discharging device 2000 may comprise a support portion 2500. The support portion 2500 may comprise a first support portion 2510 and a second support portion 2520. The battery cells may be detachably disposed on the support portion 2500, and the battery cells may be supported by the support portion 2500. In this case, a space on the support portion 2500 in which the battery cells are disposed may be the detachable space 10.

In one embodiment, when the battery cells are disposed in the detachable space 10, charging and discharging of the battery cells through the charging-discharging device 2000 may be performed. In one embodiment, when the calibration device 1000 described with reference to FIGS. 1 to 3 is disposed in the detachable space 10 instead of the battery cells, calibration of the charging-discharging device 2000 through the calibration device 1000 may be performed. In this case, the calibration device 1000 may be detachably disposed in the detachable space 10.

In one embodiment, the charging-discharging device 2000 may further comprise a charging-discharging frame 2400 in which the charging-discharging portion 2200 and the temperature measurement portion 2300 are disposed. For example, the charging-discharging portion 2200 and the temperature measurement portion 2300 may be disposed in a receiving space defined by the charging-discharging frame 2400. In this case, at least a part of the charging-discharging terminal portion 400 and at least a part of the temperature measurement terminal portion 500 may be respectively exposed to the outside of the charging-discharging frame 2400. In addition, at least a part of the charging-discharging control portion 2100 may be exposed to the outside of the charging-discharging frame 2400. However, the present disclosure is not limited thereto. For example, the charging-discharging control portion 2100 may also be disposed in the receiving space of the charging-discharging frame 2400.

In one embodiment, the charging-discharging frame 2400 may be movable toward the detachable space 10. For example, when the battery cells are disposed in the detachable space 10, the charging-discharging frame 2400 may be movable toward the battery cells disposed in the detachable space 10 such that the charging-discharging terminal portion 400 is electrically connected to electrodes (e.g., a positive electrode and a negative electrode) of the battery cells. In another example, when the calibration device 1000 is disposed in the detachable space 10, the charging-discharging frame 2400 may be movable toward the calibration device 1000 disposed in the detachable space 10 such that the charging-discharging terminal portion 400 and the temperature measurement terminal portion 500 are respectively connected to the first calibration terminal portion 200 (see FIG. 1) and the second calibration terminal portion 300 (see FIG. 1).

In one embodiment, the charging-discharging frame 2400 may comprise a first charging-discharging frame 2410 and a second charging-discharging frame 2420 facing each other with the detachable space 10 interposed therebetween. The first charging-discharging frame 2410 and the second charging-discharging frame 2420 may be relatively movable in a direction approaching each other and a direction moving away from each other with the detachable space 10 interposed therebetween.

In one embodiment, the charging-discharging portion 2200 may comprise a plurality of charging-discharging portions stacked in two or more stages. For example, the charging-discharging portion 2200 may comprise a first charging-discharging portion 2210, a second charging-discharging portion 2220, and a third charging-discharging portion 2230 stacked along the third direction DR3. The first charging-discharging portion 2210, the second charging-discharging portion 2220, and the third charging-discharging portion 2230 may be disposed in the receiving space of the charging-discharging frame 2400, and in FIG. 5, schematic positions of the first charging-discharging portion 2210, the second charging-discharging portion 2220, and the third charging-discharging portion 2230 in the receiving space are illustrated in dotted lines.

In the above-described embodiment, the charging-discharging terminal portion 400 may be composed of a plurality of charging-discharging terminal portions corresponding to the plurality of charging-discharging portions. For example, the first charging-discharging portion 2210 may comprise a first charging-discharging terminal portion 410, the second charging-discharging portion 2220 may comprise a second charging-discharging terminal portion 420, and the third charging-discharging portion 2230 may comprise a third charging-discharging terminal portion 430.

In this case, at least a part of the first charging-discharging terminal portion 410, at least a part of the second charging-discharging terminal portion 420, and at least a part of the third charging-discharging terminal portion 430 may be respectively exposed to the outside of the charging-discharging frame 2400. In addition, the first charging-discharging terminal portion 410, the second charging-discharging terminal portion 420, and the third charging-discharging terminal portion 430 may each be provided in plurality, and these may respectively correspond in a one-to-one manner to the plurality of first-first calibration terminal portions 210, the plurality of first-second calibration terminal portions 220, and the plurality of first-third calibration terminal portions 230 described with reference to FIGS. 2 and 3.

In one embodiment, the temperature measurement portion 2300 may comprise a plurality of temperature measurement portions stacked in two or more stages. For example, the temperature measurement portion 2300 may comprise a first temperature measurement portion 2310, a second temperature measurement portion 2320, and a third temperature measurement portion 2330 stacked along the third direction DR3. The first temperature measurement portion 2310, the second temperature measurement portion 2320, and the third temperature measurement portion 2330 may be disposed in the receiving space of the charging-discharging frame 2400, and in FIG. 5, schematic positions of the first temperature measurement portion 2310, the second temperature measurement portion 2320, and the third temperature measurement portion 2330 in the receiving space are illustrated in dotted lines.

In the above-described embodiment, the temperature measurement terminal portion 500 may be composed of a plurality of temperature measurement terminal portions corresponding to the plurality of temperature measurement portions. For example, the first temperature measurement portion 2310 may comprise a first temperature measurement terminal portion 510, the second temperature measurement portion 2320 may comprise a second temperature measurement terminal portion 520, and the third temperature measurement portion 2330 may comprise a third temperature measurement terminal portion 530.

In this case, at least a part of the first temperature measurement terminal portion 510, at least a part of the second temperature measurement terminal portion 520, and at least a part of the third temperature measurement terminal portion 530 may be respectively exposed to the outside of the charging-discharging frame 2400. In addition, the first temperature measurement terminal portion 510, the second temperature measurement terminal portion 520, and the third temperature measurement terminal portion 530 may each be provided in plurality, and these may respectively correspond in a one-to-one manner to the plurality of second-first calibration terminal portions 310, the plurality of second-second calibration terminal portions 320, and the plurality of second-third calibration terminal portions 330 described with reference to FIGS. 2 and 3.

In one embodiment, the first temperature measurement portion 2310, the second temperature measurement portion 2320, and the third temperature measurement portion 2330 may be disposed at substantially the same positions as the first charging-discharging portion 2210, the second charging-discharging portion 2220, and the third charging-discharging portion 2230, respectively. In this case, the first temperature measurement portion 2310, the second temperature measurement portion 2320, and the third temperature measurement portion 2330 may be provided as components physically and/or logically separated from the first charging-discharging portion 2210, the second charging-discharging portion 2220, and the third charging-discharging portion 2230, respectively.

Meanwhile, in FIG. 5, for clear and concise description, embodiments in which the charging-discharging portion 2200 and the temperature measurement portion 2300 are each configured in three stages are illustrated, but the present disclosure is not limited thereto. The charging-discharging portion 2200 and the temperature measurement portion 2300 may each independently be configured in one stage, two stages, or four or more stages.

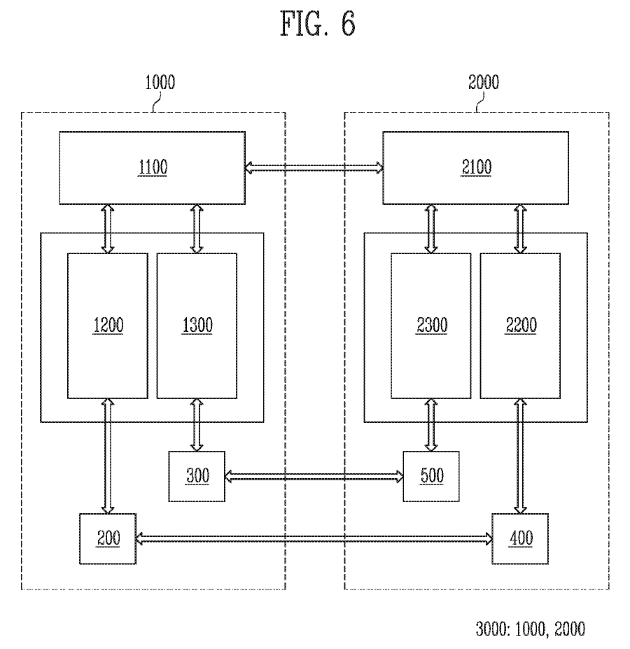

FIG. 6 is a diagram showing a control block diagram of a charging-discharging system according to the present disclosure.

Hereinafter, descriptions of contents overlapping with those described with reference to FIGS. 1 to 5 may be omitted.

Referring to FIG. 6, a charging-discharging system 3000 may comprise: a charging-discharging device 2000 defining a detachable space 10 (see FIG. 5) in which one or more battery cells are detachably disposed and charging and discharging the battery cells; and a calibration device 1000 detachably disposed in the detachable space 10.

Here, the charging-discharging device 2000 may comprise: a charging-discharging portion 2200 including a charging-discharging terminal portion 400 for charging and discharging the battery cells, and outputting current and voltage to the charging-discharging terminal portion 400 at a preset set intensity value; a temperature measurement portion 2300 including a temperature measurement terminal portion 500 for sensing a temperature of the detachable space 10, and measuring a temperature of the temperature measurement terminal portion 500 to obtain a measured temperature value; and a charging-discharging control portion 2100 for controlling the charging-discharging portion 2200 and the temperature measurement portion 2300.

In addition, the calibration device 1000 may comprise: a first calibration portion 1200 including a first calibration terminal portion 200 connectable to the charging-discharging terminal portion 400, and measuring current and voltage applied to the first calibration terminal portion 200 to obtain a measured intensity value; and a second calibration portion 1300 including a second calibration terminal portion 300 connectable to the temperature measurement terminal portion 500, and setting a temperature of the second calibration terminal portion 300 to a preset set temperature value.

In one embodiment, the charging-discharging terminal portion 400 and the first calibration terminal portion 200 may each be provided in plurality, and the plurality of charging-discharging terminal portions 400 and the plurality of first calibration terminal portions 200 may correspond to each other in a one-to-one manner. For example, as described with reference to FIGS. 2 and 3, the first calibration terminal portion 200 may comprise a plurality of first-first calibration terminal portions 210, a plurality of first-second calibration terminal portions 220, and a plurality of first-third calibration terminal portions 230. In this case, as described with reference to FIG. 5, the charging-discharging terminal portion 400 may comprise a first charging-discharging terminal portion 410, a second charging-discharging terminal portion 420, and a third charging-discharging terminal portion 430, wherein the first charging-discharging terminal portion 410 may be provided in plurality to correspond in a one-to-one manner with the plurality of first-first calibration terminal portions 210, the second charging-discharging terminal portion 420 may be provided in plurality to correspond in a one-to-one manner with the plurality of first-second calibration terminal portions 220, and the third charging-discharging terminal portion 430 may be provided in plurality to correspond in a one-to-one manner with the plurality of first-third calibration terminal portions 230.

In one embodiment, the temperature measurement terminal portion 500 and the second calibration terminal portion 300 may each be provided in plurality, and the plurality of temperature measurement terminal portions 500 and the plurality of second calibration terminal portions 300 may correspond to each other on a one-to-one basis. For example, as described with reference to FIGS. 2 and 3, the second calibration terminal portion 300 may comprise a plurality of second-first calibration terminal portions 310, a plurality of second-second calibration terminal portions 320, and a plurality of second-third calibration terminal portions 330. In this case, as described with reference to FIG. 5, the temperature measurement terminal portion 500 may comprise a first temperature measurement terminal portion 510, a second temperature measurement terminal portion 520, and a third temperature measurement terminal portion 530, wherein the first temperature measurement terminal portion 510 may be provided in plurality to correspond on a one-to-one basis with the plurality of second-first calibration terminal portions 310, the second temperature measurement terminal portion 520 may be provided in plurality to correspond on a one-to-one basis with the plurality of second-second calibration terminal portions 320, and the third temperature measurement terminal portion 530 may be provided in plurality to correspond on a one-to-one basis with the plurality of second-third calibration terminal portions 330.

In the aforementioned embodiment, the number of the plurality of temperature measurement terminal portions 500 may be equal to or less than the number of the plurality of charging/discharging terminal portions 400. The plurality of temperature measurement terminal portions 500 may be provided in a suitable number to determine whether a fire occurs at different positions of the detachment space 10, and as long as such determination of fire occurrence can be made with sufficient reliability, the number of the plurality of temperature measurement terminal portions 500 may be equal to or less than the number of the plurality of charging/discharging terminal portions 400. Accordingly, the spatial efficiency of the charging/discharging device 2000 may be improved.

In one embodiment, the calibration device 1000 may further comprise a calibration control portion 1100 that controls the first calibration portion 1200 and the second calibration portion 1300.

In one embodiment, the calibration control portion 1100 may exchange control signals with the charging/discharging control portion 2100. For example, the calibration control terminals 100 of the calibration control portion 1100 (see FIGS. 2 and 3) may be connected to the charging/discharging control portion 2100, through which the calibration control portion 1100 and the charging/discharging control portion 2100 can exchange control signals.

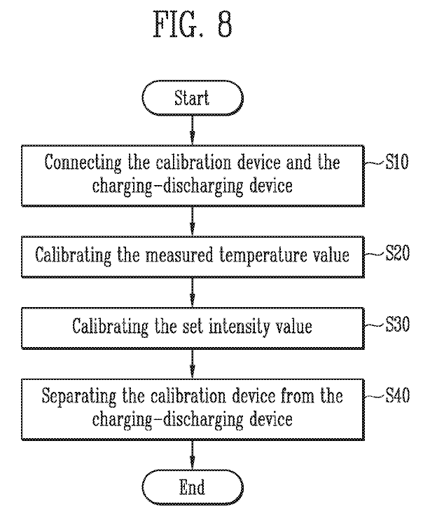

In the aforementioned embodiment, the calibration control portion 1100 may provide the measured intensity value and the set temperature value to the charging/discharging control portion 2100. Based on this, the charging/discharging control portion 2100 may perform calibration of the measured temperature value and calibration of the set intensity value. Details of the calibration of the measured temperature value and the set intensity value are described below with reference to FIGS. 8 to 10.

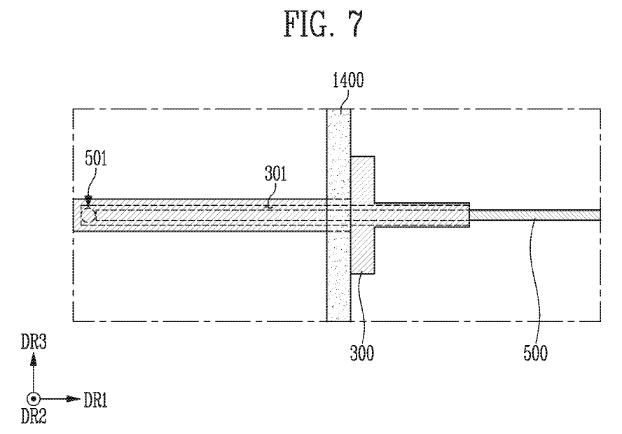

FIG. 7 is a diagram schematically showing an example in which a second calibration terminal portion included in the calibration device according to the present disclosure is connected to a temperature measurement terminal portion included in the charging-discharging device according to the present disclosure.

Referring to FIG. 7, in one embodiment, the temperature measurement terminal portion 500 may extend in a predetermined direction, and the second calibration terminal portion 300 may define an insertion space 301 into which the extended end of the temperature measurement terminal portion 500 is inserted.

In the aforementioned embodiment, the temperature measurement terminal portion 500 may further comprise a temperature sensor 501 disposed at the extended end. The temperature sensor 501 may measure the temperature of the second calibration terminal portion 300 (e.g., the set temperature value) by contacting at least a portion of the second calibration terminal portion 300 within the insertion space 301.

FIG. 8 is a flowchart for explaining an example of a calibration method of the charging-discharging device using the charging-discharging system of FIG. 6.

Referring to FIG. 8, a calibration method of the charging/discharging device 2000 using the charging/discharging system 3000 may include: a step of connecting the calibration device 1000 and the charging/discharging device 2000 S10 (hereinafter referred to as "first step"); a step of calibrating the measured temperature value S20 (hereinafter referred to as "second step"); a step of calibrating the set current/voltage value S30 (hereinafter referred to as "third step"); and a step of separating the calibration device 1000 from the charging/discharging device 2000 S40 (hereinafter referred to as "fourth step").

In the first step S10, the calibration device 1000 may be disposed in the detachable space 10 and supported by the support portion 2500. This may be performed, for example, by a server included in the charging/discharging system 3000 and a transfer device (not shown) that exchanges control signals with the server. Thereafter, as the charging/discharging frame 2400 moves toward the calibration device 1000, the charging/discharging terminal portion 400 and the temperature measurement terminal portion 500 may be connected to the first calibration terminal portion 200 and the second calibration terminal portion 300, respectively. This may be performed, for example, by the server and the charging/discharging control unit 2100 that exchanges control signals with the server.

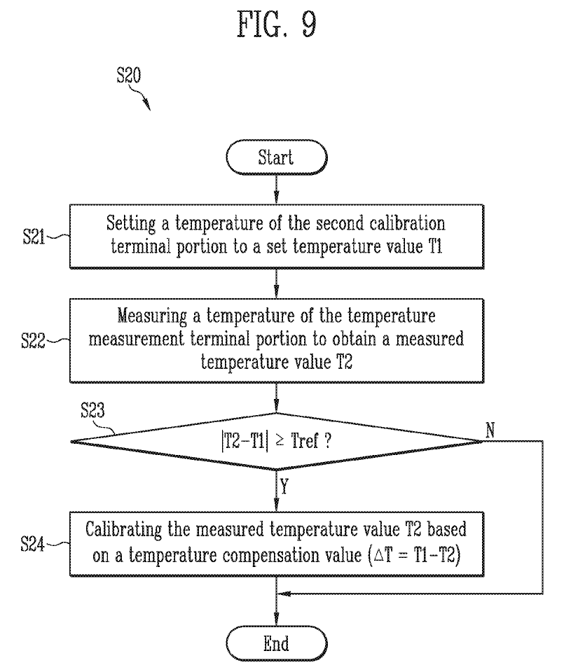

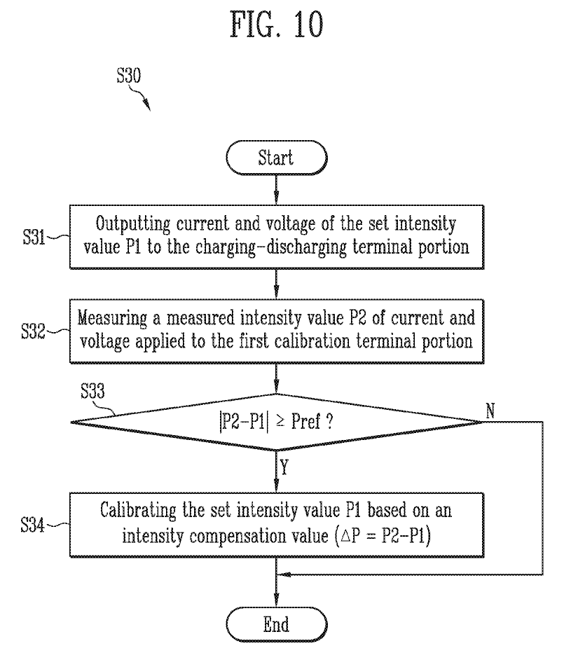

In the second step S20 and the third step S30, calibration of charging/discharging device 2000 using the calibration device 1000 may be performed. Details thereof will be described later with reference to FIGS. 9 and 10.

In the fourth step S40, as the charging/discharging frame 2400 moves in a direction away from the calibration device 1000, the charging/discharging terminal portion 400 and the temperature measurement terminal portion 500 may be separated from the first calibration terminal portion 200 and the second calibration terminal portion 300, respectively. This may be performed, for example, by the server and the charging/discharging control unit 2100 that exchanges control signals with the server. Thereafter, the calibration device 1000 may be removed from the charging/discharging device 2000. This may be performed, for example, by the server and the transfer device that exchanges control signals with the server.

FIG. 9 is a flowchart for explaining a step of calibrating a measured temperature value of FIG. 8.

Referring to FIG. 9, in the second step S20, the charging/discharging control unit 2100 may calibrate the measured temperature value based on the set temperature value and the measured temperature value.

More specifically, the second step S20 may include setting the temperature of the second calibration terminal portion 300 to the set temperature value T1 in the second-first step S21, measuring the temperature of the temperature measurement terminal portion 500 to obtain the measured temperature value T2 in the second-second step S22, comparing the absolute value of the difference between the measured temperature value T2 and the set temperature value T1 with the reference temperature value Tref in the second-third step S23, and calibrating the measured temperature value T2 based on the temperature compensation value △T in the second-fourth step S24.

In the second-first step S21, the second calibration unit 1300 may set the temperature of the second calibration terminal portion 300 to the set temperature value T1. This may be performed under the control of the calibration control unit 1100. For example, the calibration control unit 1100 may store the predetermined set temperature value T1 and transmit the stored set temperature value T1 to the second calibration unit 1300.

In this case, the calibration control unit 1100 may be able to measure whether the temperature of the second calibration terminal portion 300 set by the second calibration unit 1300 matches the set temperature value T1. Here, when the temperature of the second calibration terminal portion 300 matches the set temperature value T1, the subsequent steps S22, S23, and S24 may be performed. In contrast, when the temperature of the second calibration terminal portion 300 does not match the set temperature value T1, the calibration device 1000 may be separated from the charging/discharging device 2000 by the server and the transfer device of the charging/discharging system 3000, and the calibration of the calibration device 1000 may be performed.

In the second-second step S22, the temperature measurement unit 2300 may measure the temperature of the temperature measurement terminal portion 500 connected to the second calibration terminal portion 300 to obtain the measured temperature value T2. The temperature measurement unit 2300 may provide the obtained measured temperature value T2 to the charging/discharging control unit 2100, and the charging/discharging control unit 2100 may store the measured temperature value T2. Meanwhile, the calibration control unit 1100 may provide the stored set temperature value T1 to the charging/discharging control unit 2100. Accordingly, the charging/discharging control unit 2100 may store both the set temperature value T1 and the measured temperature value T2.

In the second-third step S23, the charging/discharging control unit 2100 may determine whether the absolute value of the difference between the measured temperature value T2 and the set temperature value T1 is equal to or greater than the reference temperature value Tref. When the absolute value of the difference between the measured temperature value T2 and the set temperature value T1 is equal to or greater than the reference temperature value Tref, the subsequent second-fourth step S24 may be performed. When the absolute value of the difference between the measured temperature value T2 and the set temperature value T1 is less than the reference temperature value Tref, the subsequent second-fourth step S24 may not be performed.

In the second-fourth step S24, when the absolute value of the difference between the measured temperature value T2 and the set temperature value T1 is equal to or greater than the reference temperature value Tref, the charging/discharging control unit 2100 may correct the measured temperature value T2 based on the temperature compensation value △T obtained by subtracting the measured temperature value T2 from the set temperature value T1. For example, when the absolute value of the difference between the measured temperature value T2 and the set temperature value T1 is equal to or greater than the reference temperature value Tref, the charging/discharging control unit 2100 may store the temperature compensation value △T obtained by subtracting the measured temperature value T2 from the set temperature value T1. Thereafter, the charging/discharging control unit 2100 may correct the measured temperature value T2 such that the measured temperature value T2 is recognized as the sum of the measured temperature value T2 provided from the temperature measurement unit 2300 and the temperature compensation value △T.

For example, in an embodiment where the measured temperature value T2 measured from the temperature measurement terminal 500 of the temperature measurement unit 2300 is a first temperature value, the set temperature value T1 is a second temperature value, and the reference temperature value Tref is a third temperature value, when the absolute value of the difference between the first temperature value and the second temperature value is equal to or greater than the third temperature value, the charging/discharging control unit 2100 may correct so that the first temperature value measured and provided from the temperature measurement terminal 500 is not recognized as the measured temperature value T2, but the sum of the first temperature value measured and provided from the temperature measurement terminal 500 and the temperature compensation value △T (second temperature value minus first temperature value) is recognized as the measured temperature value T2.

In this way, even if the reliability of the measured temperature value T2 measured through the temperature measurement terminal 500 and the temperature measurement unit 2300 decreases due to repeated use of the charging/discharging device 2000, the measured temperature value T2 can be corrected through the charging/discharging system 3000 of the present disclosure, and thereby, the reliability of the charging/discharging device 2000 can be effectively maintained.

FIG. 10 is a flowchart for explaining a step of calibrating a set intensity value of FIG. 8.

Referring to FIG. 10, through the third step S30, the charging/discharging control unit 2100 may correct the set intensity value P1 based on the set intensity value P1 and the measured intensity value P2.

More specifically, the third step S30 may include: a step of outputting a current and voltage of the set intensity value P1 to the charging/discharging terminal 400, S31, hereinafter referred to as the third-first step; a step of measuring the measured intensity value P2 of the current and voltage applied to the first calibration terminal 200, S32, hereinafter referred to as the third-second step; a step of comparing the absolute value of the difference between the measured intensity value P2 and the set intensity value P1 with the reference intensity value Pref, S33, hereinafter referred to as the third-third step; and a step of correcting the set intensity value P1 based on the intensity compensation value △P, S34, hereinafter referred to as the third-fourth step.

In the third-first step S31, the charging/discharging unit 2200 may output the current and voltage of the set intensity value P1 to the charging/discharging terminal 400. This may be performed under the control of the charging/discharging control unit 2100. For example, the charging/discharging control unit 2100 may store the preset set intensity value P1 and provide the stored set intensity value P1 to the charging/discharging unit 2200.

In the third-second step S32, the first calibration unit 1200 may measure the measured intensity value P2 of the current and voltage applied to the first calibration terminal 200. The first calibration unit 1200 may provide the measured intensity value P2 to the charging/discharging control unit 2100 through the calibration control unit 1100. The charging/discharging control unit 2100 may store the measured intensity value P2.

In the third-third step S33, the charging/discharging control unit 2100 may determine whether the absolute value of the difference between the measured intensity value P2 and the set intensity value P1 is equal to or greater than the reference intensity value Pref. When the absolute value of the difference between the measured intensity value P2 and the set intensity value P1 is equal to or greater than the reference intensity value Pref, the subsequent third-fourth step S34 may be performed. When the absolute value of the difference between the measured intensity value P2 and the set intensity value P1 is less than the reference intensity value Pref, the subsequent third-fourth step S34 may not be performed.

In the third-fourth step S34, when the absolute value of the difference between the measured intensity value P2 and the set intensity value P1 is equal to or greater than the reference intensity value Pref, the charging/discharging control unit 2100 may correct the set intensity value P1 based on the intensity compensation value △P obtained by subtracting the set intensity value P1 from the measured intensity value P2. For example, when the absolute value of the difference between the measured intensity value P2 and the set intensity value P1 is equal to or greater than the reference intensity value Pref, the charging/discharging control unit 2100 may store the intensity compensation value △P obtained by subtracting the set intensity value P1 from the measured intensity value P2. Thereafter, the charging/discharging control unit 2100 may be calibrated to recognize the set intensity value P1 as the sum of the set intensity value P1 and the intensity compensation value △P.

For example, in an embodiment where the measured intensity value P2 measured from the charging/discharging terminal 400 of the charging/discharging unit 2200 is a first intensity value, the set intensity value P1 is a second intensity value, and the reference intensity value Pref is a third intensity value, when the absolute value of the difference between the first intensity value and the second intensity value is equal to or greater than the third intensity value, the charging/discharging control unit 2100 may be calibrated such that it does not recognize the second intensity value provided from the server of the charging/discharging system 3000 as the set intensity value P1, but instead recognizes the set intensity value P1 as the sum of the second intensity value provided from the server and the intensity compensation value △P, which is the first intensity value minus the second intensity value.

In this way, even if the reliability of the current and voltage intensity, which are set to be output as the set intensity value P1 through the charging-discharging terminal 400 and the charging-discharging unit 2200, is degraded due to repeated use of the charging-discharging device 2000, the set intensity value P1 may be corrected through the charging-discharging system 3000, and accordingly, the reliability of the charging-discharging device 2000 can be effectively maintained.

Meanwhile, referring again to FIGS. 8 to 10, the charging-discharging control unit 2100 may simultaneously perform the correction of the measured temperature value S20 and the correction of the set intensity value S30. In other words, in the charging-discharging system 3000, the correction through the first correction unit 1200 and the correction through the second correction unit 1300 may be performed simultaneously. Accordingly, the calibration efficiency of the charging-discharging system 3000 can be further improved.

The present disclosure may be embodied in various forms, and the scope of the disclosure is not limited to the above-described embodiments. Therefore, if a modified embodiment includes the elements of the claims of the present disclosure, it should be regarded as falling within the scope of the present disclosure.

What is claimed is:

1. A charging-discharging system comprising:
a charging-discharging device defining a detachable space in which one or more battery cells are detachably disposed and charging and discharging the battery cells; and
a calibration device detachably disposed in the detachable space,
wherein the charging-discharging device comprises:
a charging-discharging portion including a charging-discharging terminal portion for charging-discharging the battery cells, and outputting current and voltage to the charging-discharging terminal portion at a preset set intensity value;
a temperature measurement portion including a temperature measurement terminal portion for sensing a temperature of the detachable space, and measuring a temperature of the temperature measurement terminal portion to obtain a measured temperature value; and
a charging-discharging control portion for controlling the charging-discharging portion and the temperature measurement portion,
wherein the calibration device comprises:
a first calibration portion including a first calibration terminal portion connectable to the charging-discharging terminal portion, and measuring current and voltage applied to the first calibration terminal portion to obtain a measured intensity value; and
a second calibration portion including a second calibration terminal portion connectable to the temperature measurement terminal portion, and setting a temperature of the second calibration terminal portion to a preset set temperature value.

2. The charging-discharging system according to claim 1, wherein the charging-discharging terminal portions and the first calibration terminal portions are respectively provided in plurality, and the plurality of charging-discharging terminal portions and the plurality of first calibration terminal portions correspond to each other in a one-to-one manner.

3. The charging-discharging system according to claim 2, wherein the temperature measurement terminal portions and the second calibration terminal portions are respectively provided in plurality, and the plurality of temperature measurement terminal portions and the plurality of second calibration terminal portions correspond to each other in a one-to-one manner.

4. The charging-discharging system according to claim 3, wherein the number of the plurality of temperature measurement terminal portions is less than or equal to the number of the plurality of charging-discharging terminal portions.

5. The charging-discharging system according to claim 1, wherein the temperature measurement terminal portion extends in a preset direction, and the second calibration terminal portion defines an insertion space into which an extension end of the temperature measurement terminal portion is inserted.

6. The charging-discharging system according to claim 5, wherein the temperature measurement terminal portion further comprises a temperature sensor disposed at the extension end.

7. The charging-discharging system according to claim 1, wherein the charging-discharging device further comprises a charging-discharging frame in which the charging-discharging portion and the temperature measurement portion are disposed.

8. The charging-discharging system according to claim 7, wherein the charging-discharging frame is movable toward the calibration device disposed in the detachable space such that the charging-discharging terminal portion and the temperature measurement terminal portion are respectively connected to the first calibration terminal portion and the second calibration terminal portion.

9. The charging-discharging system according to claim 1, wherein the charging-discharging control portion calibrates the measured temperature value based on the set temperature value and the measured temperature value.

10. The charging-discharging system according to claim 9, wherein when an absolute value of a difference between the measured temperature value and the set temperature value is greater than or equal to a reference temperature value, the charging-discharging control portion calibrates the measured temperature value based on a temperature compensation value obtained by subtracting the measured temperature value from the set temperature value.

11. The charging-discharging system according to claim 9, wherein the charging-discharging control portion calibrates the set intensity value based on the set intensity value and the measured intensity value.

12. The charging-discharging system according to claim 11, wherein when an absolute value of a difference between the measured intensity value and the set intensity value is greater than or equal to a reference intensity value, the charging-discharging control portion calibrates the set intensity value based on an intensity compensation value obtained by subtracting the set intensity value from the measured intensity value.

13. The charging-discharging system according to claim 9, wherein the charging-discharging control portion simultaneously performs calibration of the measured temperature value and calibration of the set intensity value.

14. The charging-discharging system according to claim 1, wherein the calibration device further comprises a calibration control portion for controlling the first calibration portion and the second calibration portion.

15. The charging-discharging system according to claim 14, wherein the calibration control portion is capable of measuring whether a temperature of the second calibration terminal portion set by the second calibration portion matches the set temperature value.

16. The charging-discharging system according to claim 14, wherein the calibration control portion transmits and receives a control signal to and from the charging-discharging control portion.

17. The charging-discharging system according to claim 16, wherein the calibration control portion provides the measured intensity value and the set temperature value to the charging-discharging control portion.

18. The charging-discharging system according to claim 1, wherein calibration through the first calibration portion and calibration through the second calibration portion are performed simultaneously.
